(19) United States
(12) Patent Application Publication
(10) Pub. No.: US 2011/0157409 A1
(43) Pub. Date: Jun. 30, 2011

(54) IMAGE QUALITY ADJUSTING DEVICE, IMAGE QUALITY ADJUSTING METHOD, AND IMAGE QUALITY ADJUSTING PROGRAM

(75) Inventor: Takeshi Adachi, Saitama (JP)

(73) Assignees: MITSUMI ELECTRIC CO., LTD., Tokyo (JP); ATRC CORPORATION, Saitama (JP)

(21) Appl. No.: 13/060,393

(22) PCT Filed: Aug. 27, 2009
(86) PCT No.: PCT/JP2009/064983

§ 371 Date: Feb. 23, 2011

(30) Foreign Application Priority Data
Aug. 27, 2008 (JP) 2008-218523
Aug. 20, 2009 (JP) 2009-190665

(51) Int. Cl. G06K 9/00; H04N 5/228

(52) U.S. Cl. 348/222.1; 382/162; 348/E05.031

(57) ABSTRACT

An image quality adjusting device 12 includes an imaging unit 21 capturing a screen of a display terminal 11 using a spectroscopic camera and an RGB camera to obtain image information; an analysis unit 22 obtaining color data, profile data, and histogram data from the image information obtained by the imaging unit 21 and analyzing image quality characteristics including still image characteristics and video image characteristic; and an image quality adjusting unit 23 generating a look-up table (LUT), which is used to adjust the image quality of the display terminal 11 by means of predetermined image quality adjustment parameters, based on image quality evaluation data of the display terminal 11 obtained by the analysis unit 22, and updating image quality information preset in the display terminal 11 based on the generated look-up table to adjust the image quality of the display terminal 11.

### TECHNICAL FIELD

The present invention generally relates to an image quality adjusting device, an image quality adjusting method, and an image quality adjusting program. More particularly, the present invention relates to an image quality adjusting device, an image quality adjusting method, and an image quality adjusting program for accurately and consistently adjusting image quality characteristics.

### BACKGROUND ART

The definition and image quality of broadcasting equipment and display terminals have improved rapidly due to digitization. In a typical image quality adjusting process for a mass-produced display terminal such as a liquid crystal television or a plasma television, a worker visually inspects the television screen and adjusts the image quality characteristics such as color and brightness. With this method, however, the accuracy of adjusting the image quality may vary depending on, for example, the physical condition of the worker and therefore the image quality characteristics may vary from one display terminal to another. Also, when there are multiple workers or when workers change day by day, it is more difficult to consistently adjust image quality characteristics.

Meanwhile, the image quality of analog display terminals can be evaluated stably and accurately by monitoring analog waveforms using, for example, an oscilloscope or a synchroscope. However, unlike analog waveforms, it is difficult to quantitatively evaluate the image quality by directly monitoring digital waveforms. For this reason, the process of adjusting the image quality of digital display terminals has been generally performed by skilled workers based on visual inspection results. However, the reliability of visual inspection results varies depending on the worker and this makes it difficult for an engineer to design the image quality of a digital display terminal such as a flat panel display.

Here, patent document 1 discloses an image quality adjusting method for a cathode-ray tube display which makes it possible for an unskilled worker to adjust the image quality. In the disclosed method, a display screen image of a color cathode-ray tube display is taken by an array of cameras and the image quality is adjusted using an interconnecting neural network including interconnected nodes and having a function to minimize energy.

[Patent document 1] Japanese Laid-Open Patent Publication No. 7-170527

### DISCLOSURE OF INVENTION

### Problems to be Solved by the Invention

As described above, in related-art methods for evaluating and adjusting the image quality of a display terminal, an image signal is input to the display terminal and a design engineer or a production engineer sets image quality adjustment parameters based on visual inspection results of the displayed image. However, the visual inspection results may vary depending on various factors such as the personal preference, the physical condition of the engineer, the viewing environment, the display screen size, and the national character. Therefore, with the related-art methods, it is difficult to stably and quantitatively evaluate and accurately adjust the image quality. In other words, the entire process from design and development to mass production of display terminals is typically performed according to a cut-and-try method without using quantitative evaluation data for compensating for the variation in visual inspection results. Also, since the variation in image quality between production lots is not quantitatively managed, it is difficult to accurately determine the cause of an error in a product on the market and to find out a solution for the error.

Patent document 1 discloses an instruction providing unit that automatically calculates positions where adjustment parts such as magnet pieces are to be attached. However, patent document 1 does not provide a method or configuration for obtaining image quality parameters of an image displayed on a display terminal, quantitatively evaluating the obtained image quality parameters, obtaining adjustment data for adjusting the image quality characteristics of the display terminal based on the evaluation results, and feeding back the adjustment data to a control unit to accurately and consistently adjust the image quality characteristics.

An aspect of the present invention provides an image quality adjusting device, an image quality adjusting method, and an image quality adjusting program that make it possible to accurately and consistently adjust image quality characteristics.

### Means for Solving the Problems

Aspects of the present invention make it possible to reduce or solve one or more of the above problems caused by the limitations and disadvantages of the related art.

An aspect of the present invention provides an image quality adjusting device (12) for adjusting image quality of image information displayed on a screen of a display terminal (11). The image quality adjusting device (12) includes an imaging unit (21) capturing a screen of the display terminal (11) using a spectroscopic camera (41) and an RGB camera (42) to obtain the image information; an analysis unit (22) obtaining color data, profile data, and histogram data from the image information obtained by the imaging unit (21) and analyzing image quality characteristics including still image characteristics and video image characteristic; and an image quality adjusting unit (23, 72) generating a look-up table (LUT), which is used to adjust the image quality of the display terminal (11) by means of predetermined image quality adjustment parameters, based on image quality evaluation data of the display terminal (11) obtained by the analysis unit (22), and updating image quality information preset in the display terminal (11) based on the generated look-up table to adjust the image quality of the display terminal (11).

This configuration makes it possible to accurately and consistently adjust image quality characteristics. Also, this configuration makes it possible to accurately analyze the image quality of the display terminal (11) based on luminance information and color level information obtained by the spectroscopic camera (41) and the RGB camera (42).

The image quality adjusting device (12) may also include a switching unit (52) switching between an input signal input from the display terminal (11) and a camera signal obtained by the RGB camera (42); and a profile-histogram obtaining unit (56) obtaining the profile data and the histogram data from each one of the input signal and the camera signal switched by the switching unit (52).

This configuration makes it possible to obtain the profile data and the histogram data for each of the input signal and the camera signal from the RGB camera (42) and thereby makes it possible to more accurately analyze the image quality characteristics.

The image quality adjusting device (12) may also include an image quality adjustment control unit (73) setting thresholds in advance for the profile data and the histogram data obtained by the analysis unit (22) and causing the image quality adjusting unit (23) to statically or dynamically adjust the image quality based on the thresholds.

This configuration makes it possible to statically or dynamically perform image quality adjustment based on the status of a production line of the display terminal (11) and the analysis results of the display terminal (11).

The image quality adjustment control unit (73) may be configured to generate an image quality adjustment look-up table based on the profile data and the histogram data obtained by the analysis unit (22) and to dynamically perform feedback control on the display terminal (11).

This configuration makes it possible to quickly perform feedback control for image quality adjustment using the image quality adjustment look-up table.

Another aspect of the present invention provides a method for adjusting image quality of image information displayed on a screen of a display terminal (11). The method includes an image signal obtaining step (S01) of capturing the screen of the display terminal (11) by an imaging unit (21) including a spectroscopic camera (41) and an RGB camera (41) to obtain an image signal indicating the image information; an analysis step (S02) of obtaining color data, profile data, and histogram data from the image information of a still image or a video image obtained in the image signal obtaining step (S01) and analyzing image quality characteristics including still image characteristics and video image characteristics; and an image quality adjusting step (S07) of generating a look-up table (LUT) (S06), which is used to adjust the image quality of the display terminal (11) by means of predetermined image quality adjustment parameters, based on image quality evaluation data of the display terminal (11) obtained in the analysis step (S02), and updating image quality information preset in the display terminal (11) based on the generated look-up table to adjust the image quality of the display terminal (11).

This method makes it possible to accurately and consistently adjust image quality characteristics. Also, this method makes it possible to accurately analyze the image quality of the display terminal (11) based on luminance information and color level information obtained by the spectroscopic camera (41) and the RGB camera (42).

The method may also include a switching step of switching between an input signal input from the display terminal (11) and a camera signal obtained by the RGB camera (42); and a profile-histogram obtaining step obtaining the profile data and the histogram data from each one of the input signal and the camera signal switched in the switching step.

This method makes it possible to obtain the profile data and the histogram data for each of the input signal and the camera signal from the RGB camera (42) and thereby makes it possible to more accurately analyze the image quality characteristics.

The method may also include an image quality adjustment control step (S03, S04) of setting thresholds in advance for the profile data and the histogram data obtained in the analysis step (S02) and causing the image quality to be adjusted statically or dynamically based on the thresholds in the image quality adjusting step (S07).

This method makes it possible to statically or dynamically perform image quality adjustment based on the status of a production line of the display terminal (11) and the analysis results of the display terminal (11).

The image quality adjustment control step (S03, S04) may further include generating an image quality adjustment look-up table based on the profile data and the histogram data obtained in the analysis step (S02) and dynamically performing feedback control on the display terminal (11).

This method makes it possible to quickly perform feedback control for image quality adjustment using the image quality adjustment look-up table.

Another aspect of the present invention provides a program for causing a computer to perform a method of adjusting image quality of image information displayed on a screen of a display terminal (11). The method includes an image signal obtaining step (S01) of capturing the screen of the display terminal (11) by an imaging unit (21) including a spectroscopic camera (41) and an RGB camera (41) to obtain an image signal indicating the image information; an analysis step (S2) of obtaining color data, profile data, and histogram data from the image information of a still image or a video image obtained in the image signal obtaining step (S01) and analyzing image quality characteristics including still image characteristics and video image characteristics; and an image quality adjusting step (S07) of generating a look-up table (LUT) (S06), which is used to adjust the image quality of the display terminal (11) by means of predetermined image quality adjustment parameters, based on image quality evaluation data of the display terminal (11) obtained in the analysis step (S02), and updating image quality information preset in the display terminal (11) based on the generated look-up table to adjust the image quality of the display terminal (11).

This method makes it possible to accurately and consistently adjust image quality characteristics. Also, this method makes it possible to accurately analyze the image quality of the display terminal (11) based on luminance information and color level information obtained by the spectroscopic camera (41) and the RGB camera (42). Thus, an image quality adjusting process according to an aspect of the present invention may be performed by a general-purpose personal computer where the above program is installed.

The method may also include a switching step of switching between an input signal input from the display terminal (11) and a camera signal obtained by the RGB camera (42); and a profile-histogram obtaining step obtaining the profile data and the histogram data from each one of the input signal and the camera signal switched in the switching step.

This method makes it possible to obtain the profile data and the histogram data for each of the input signal and the camera signal from the RGB camera (42) and thereby makes it possible to more accurately analyze the image quality characteristics.

The method may also include an image quality adjustment control step (S03, S04) of setting thresholds in advance for the profile data and the histogram data obtained in the analysis step (S02) and causing the image quality to be adjusted statically or dynamically based on the thresholds in the image quality adjusting step (S07).

This method makes it possible to statically or dynamically perform image quality adjustment based on the status of a production line of the display terminal (11) and the analysis results of the display terminal (11).

The image quality adjustment control step (S03, S04) may further include generating an image quality adjustment look-up table based on the profile data and the histogram data obtained in the analysis step (S02) and dynamically performing feedback control on the display terminal (11).

This method makes it possible to quickly perform feedback control for image quality adjustment using the image quality adjustment look-up table.

The reference numbers in the above descriptions are provided to facilitate the understanding of the present invention. However, the scope of the present invention is not limited by the reference numbers.

### ADVANTAGEOUS EFFECT OF THE INVENTION

An aspect of the present invention makes it possible to accurately and consistently adjust image quality characteristics of multiple display terminals.

### BRIEF DESCRIPTION OF THE DRAWINGS

FIG. 1 is a drawing illustrating an exemplary configuration of an image quality adjusting system according to an embodiment of the present invention;

FIG. 2 is a drawing illustrating an exemplary hardware configuration of an image quality adjusting device according to an embodiment of the present invention;

FIG. 3 is flowchart showing an exemplary image quality adjusting process according to an embodiment of the present invention;

FIG. 4 is a drawing illustrating an exemplary configuration of an imaging unit;

FIG. 5 is a graph showing exemplary x, y, and L values measured by a spectroscopic camera;

FIG. 6 is a graph showing an exemplary profile obtained by an RGB camera;

FIG. 7A is a graph showing exemplary luminance histogram distribution data;

FIG. 7B is a graph showing exemplary color level histogram distribution data;

FIG. 7C is a graph showing exemplary hue histogram distribution data;

FIG. 7D is a graph showing exemplary frequency histogram distribution data;

FIG. 8A is a drawing illustrating an exemplary LUT including luminance histogram patterns;

FIG. 8B is a drawing illustrating an exemplary LUT including color histogram patterns;

FIG. 9 is a drawing illustrating an exemplary configuration of an image control system;

FIG. 10A is a drawing illustrating an exemplary setting screen for automatic luminance detection enhancement control;

FIG. 10B is a drawing illustrating an exemplary setting screen for automatic color scalar detection enhancement control;

FIG. 10C is a drawing illustrating an exemplary setting screen for automatic color vector enhancement control;

FIG. 11 is a drawing illustrating an exemplary configuration of an image quality adjusting system according to another embodiment of the present invention;

FIG. 12A is a drawing illustrating a related-art system including an image quality adjusting device; and

FIG. 12B is a drawing illustrating a system including an image quality adjusting device according to an embodiment of the present invention.

### BEST MODE FOR CARRYING OUT THE INVENTION

### <Outline>

According to an embodiment of the present invention, a device (an imaging unit including a spectroscopic camera (spectrograph) and an RGB camera) is used to quantitatively measure the image quality of a display terminal. The measurements are analyzed and the analysis results are used for feedback control to adjust the image quality characteristics of the display terminal.

A spectroscopic camera used in this embodiment is capable of accurately measuring x, y, and L values on the CIE (International Commission on Illumination) chromaticity coordinate system. Meanwhile, an RGB camera is not capable of accurately measuring x, y, and L values on the CIE chromaticity coordinate system. Therefore, in this embodiment, an RGB camera is used to measure luminance energy and color energy of each pixel, and is mainly used to obtain profile data and histogram data indicating video image characteristics.

Thus, in this embodiment, a spectroscopic camera is used to measure the luminance and color values of a still image and an RGB camera is used to measure the luminance and color values of pixels of a video image (or a moving image). For example, the spectroscopic camera is used to accurately measure the image quality of a still image taking a comparatively long time. Meanwhile, the RGB camera is used to measure characteristics of a video image in real time. The luminance and color levels of pixels measured by the RGB camera are corrected based on measurements obtained by the spectroscopic camera. In other words, the RGB camera is used to quantitatively measure image quality characteristics of respective pixels of a video image and to obtain profile data and histogram data representing the image quality characteristics. The profile data and the histogram data are analyzed to appropriately adjust the image quality.

Preferred embodiments of the present invention are described below with reference to the accompanying drawings.

### <Configuration of Image Quality Adjusting System>

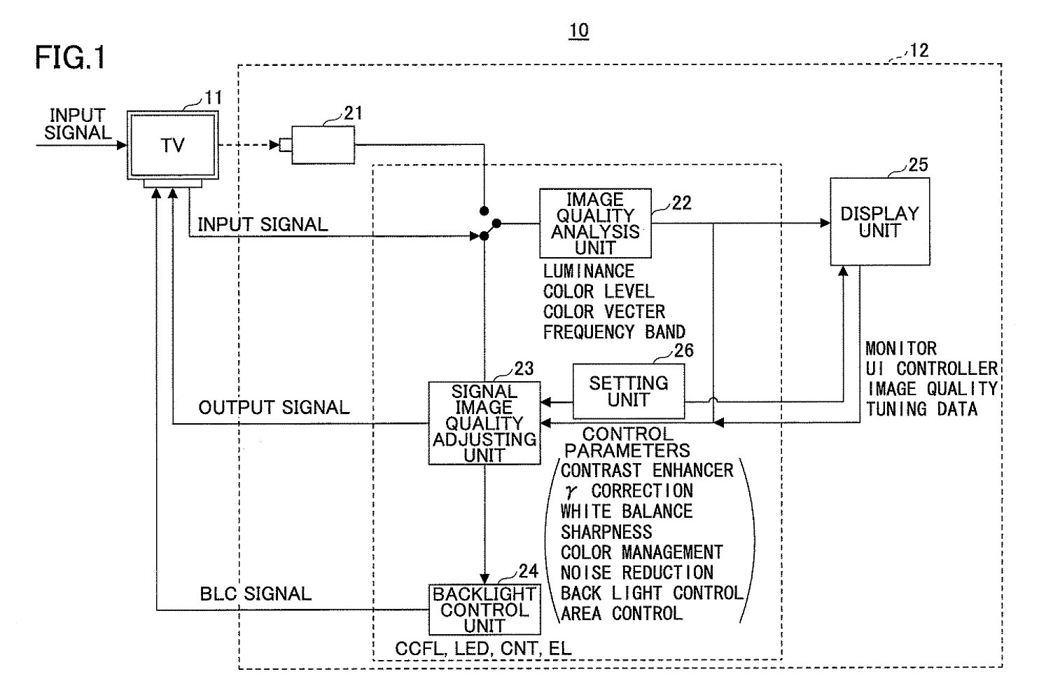

An exemplary configuration of an image quality adjusting system including an image quality adjusting device of this embodiment is described below. FIG. 1 is a drawing illustrating an exemplary configuration of an image quality adjusting system 10 of this embodiment.

As illustrated in FIG. 1, the image quality adjusting system 10 includes a display terminal 11 and an image quality adjusting device 12. The image quality adjusting device 12 includes an imaging unit 21, an image quality analysis unit 22, a signal image quality adjusting unit 23, a backlight control unit 24, a display unit 25, and a setting unit 26. The image quality analysis unit 22, the signal image quality adjusting unit 23, and the backlight control unit 24 may be combined into an integrated circuit (IC) and incorporated in the display terminal 11 such as a television.

The display terminal 11 is, for example, a television (such as a liquid crystal television or a plasma television) produced by an actual production line the image quality of which is to be adjusted. The display terminal 11 may indicate multiple display terminals that are mass-produced by a production line.

The imaging unit 21 of the image quality adjusting device 12 is a camera(s) such as a COD camera for capturing images (a still image and a video image) displayed on the display terminal 11 and thereby obtaining image signals. The imaging unit 21 may include two types of cameras such as a spectroscopic camera and an RG B camera as described later.

The image quality analysis unit 22 analyzes image quality characteristics including still image characteristics and video image characteristics based on the image signals from the imaging unit 21 and an input signal from the display terminal 11. The image quality characteristics include, for example, luminance, a color level (color vector), and a frequency band.

The signal image quality adjusting unit 23 generates look-up tables (LUT) based on the analysis results (i.e., image quality evaluation data of the display terminal 11) of the image quality analysis unit 22. The look-up tables are used to adjust the image quality of the display terminal 11 by means of predetermined image quality adjustment parameters (control parameters). The signal image quality adjusting unit 23 updates image quality information preset in the display terminal 11 based on the generated look-up tables to adjust the image quality of the display terminal 11.

The control parameters correspond to setting information (such as a monitor user interface (UI) controller and image quality tuning data) preset in the display terminal 11 and used to adjust, for example, contrast enhancer, γ-correction, white balance, sharpness, color management, noise reduction, LED backlight control, and area control.

Also, the signal image quality adjusting unit 23 generates backlight adjustment data based on various conditions set by the setting unit 26 and outputs the generated backlight adjustment data to the backlight control unit 24. When receiving the backlight adjustment data from the signal image quality adjusting unit 23, the backlight control unit 24 generates and outputs a corresponding backlight control (BLC) signal (for example, for CCFL, LED, CNT, or EL).

The display unit 25 receives the analysis results from the image quality analysis unit 22 and displays the analysis results. Also, based on the analysis results, the display unit 25 outputs the control parameters corresponding to the setting information (such as the monitor user interface (UI) controller and the image quality tuning data) of the display terminal 11 to the signal image quality adjusting unit 23.

The setting unit 26 sets various conditions such as thresholds used by the signal image quality adjusting unit 23 to generate the look-up tables and to adjust the image quality. More specifically, the setting unit 26 generates a setting screen and requests the display unit 25 to display the generated setting screen, thereby enabling the user to enter the various conditions on the setting screen using an input unit (not shown) such as a keyboard and a mouse or a dedicated controller, and stores the conditions entered by the user. The conditions to be set by the setting unit 26 are described later.

Thus, in the image quality adjusting system 10 of this embodiment, an image displayed on the display terminal 11 such as a television is captured by an evaluation camera (e.g., a CCD camera) and the quality of the captured image is analyzed using, for example, an integrated circuit (IC). Then, the analysis results are compared with preset parameters using the display unit 25 such as a general-purpose personal computer (PC) to evaluate the image quality. If the analysis results do not match the preset parameters, the image quality is adjusted to match the preset parameters.

This configuration makes it possible to consistently adjust the image quality of multiple display terminals such that they have uniform image quality characteristics. In this embodiment, image quality is evaluated using a camera instead of human eyes to consistently adjust the image quality.

### <Hardware Configuration of Image Quality Adjusting Device 12>

An exemplary hardware configuration of the image quality adjusting device 12 is described below. The image quality adjusting device 12 may be implemented by a general-purpose personal computer or a server computer and an image quality adjusting process of this embodiment may be performed by executing a program (image quality adjusting program) installed in the computer.

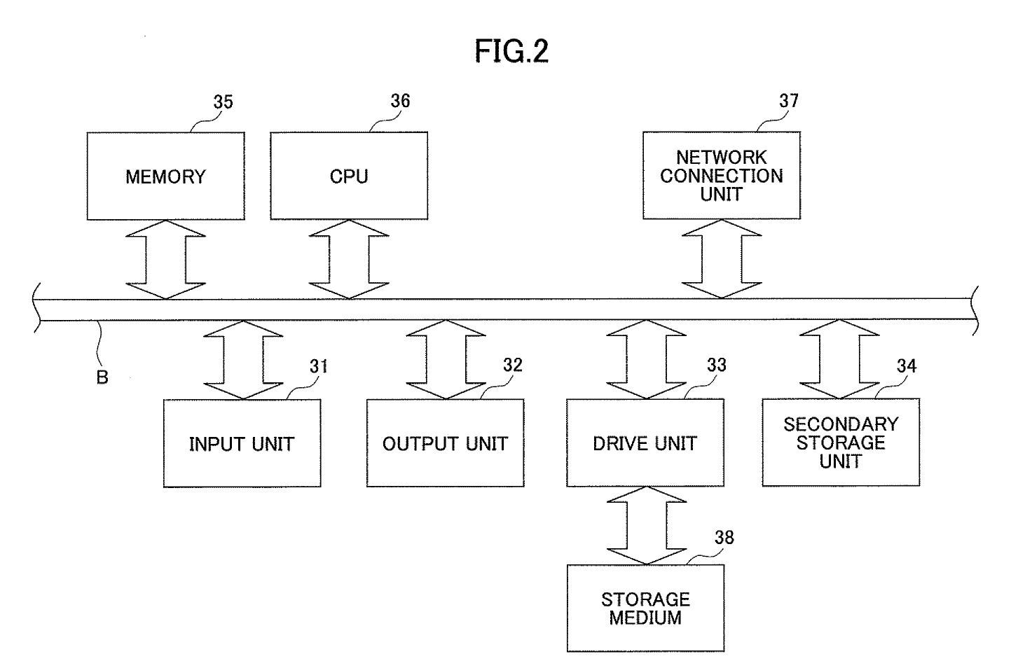

FIG. 2 is a drawing illustrating an exemplary hardware configuration of the image quality adjusting device 12. As illustrated in FIG. 2, the image quality adjusting device 12 includes an input unit 31, an output unit 32, a drive unit 33, a secondary storage unit 34, a memory 35, a central processing unit (CPU) 36 for performing various control processes, and a network connection unit 37 that are connected to each other via a system bus B.

The input unit 31 includes a keyboard and a pointing device, such as a mouse, used by the user to input operation signals such as a command to execute a program. The output unit 32 includes a display for displaying various data and windows used to operate the image quality adjusting device 12 to perform an image quality adjusting process of this embodiment. The CPU 36 displays progress status and processing results on the display according to a control program. The output unit may also include a printing function to print analysis results and other information on a recording medium such as paper for review by the user.

In this embodiment, programs to be installed into the image quality adjusting device 12 are provided, for example, by a storage medium 38 such as a CD-ROM. The storage medium 38 containing the programs is mountable on the drive unit 33. The programs stored in the storage medium 38 are installed via the drive unit 33 into the secondary storage unit 34. Instead of a CD-ROM, any other storage medium may be used as the storage medium 38. For example, storage media such as a flexible disk and a magneto-optical disk that record information optically, electrically, or magnetically and semiconductor memories such as a ROM and a flash memory that record information electrically may be used as the storage medium 38.

The secondary storage unit 34, for example, is a hard disk and stores execution programs, control programs, and measurement results. The stored execution programs, control programs, and measurement results can be retrieved from the secondary storage unit 34 as necessary.

The memory 35 temporarily stores, for example, execution programs retrieved by the CPU 36 from the secondary storage unit 34. The memory 35 includes, for example, a read only memory (ROM) and a random access memory (RAM).

The CPU 36 performs various operations, and data input/output from and to other hardware components and thereby controls the entire image quality adjusting device 12 to perform an image quality adjusting process of this embodiment. The CPU 36 can also retrieve control parameters used to execute programs and information such as setting information from the secondary storage unit 34, and store the results obtained by executing the programs and the information such as setting information in the secondary storage unit 34.

The network connection unit 37 connects the image quality adjusting device 12 to a communication network and thereby allows the image quality adjusting device 12 to obtain programs from another terminal connected to the communication network and to send the results obtained by executing the programs or the programs themselves to another terminal. Also, the network connection unit 37 allows the image quality adjusting device 12 to obtain measurement data from another terminal.

The above hardware configuration makes it possible to perform an image quality adjusting process of this embodiment. Thus, the image quality adjusting device 12 may be implemented by a personal computer and a program installed in the personal computer.

### <Image Quality Adjusting Process>

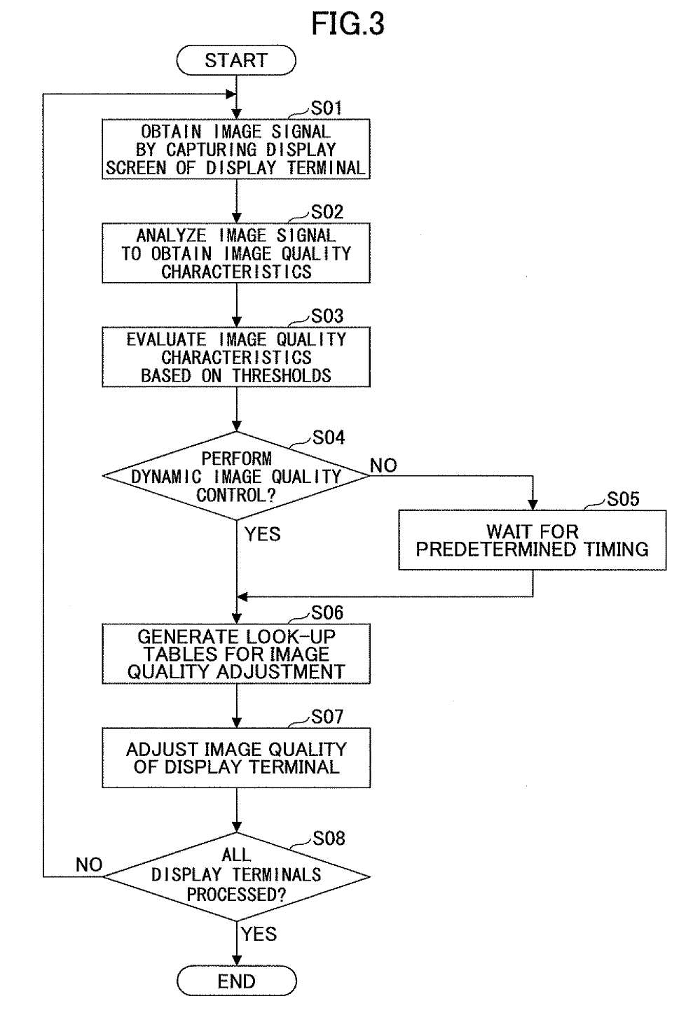

An exemplary image quality adjusting process is described below. FIG. 3 is flowchart showing an exemplary image quality adjusting process of this embodiment.

As shown in FIG. 3, an image signal is obtained by capturing a display screen of the display terminal 11 (one of multiple display terminals 11) with an imaging unit such as a camera (S01) and the image quality adjusting device 12 analyzes image quality characteristics including still image characteristics and video image characteristics based on the obtained image signal (S02). Next, the image quality adjusting device 12 evaluates the obtained image quality characteristics based on preset thresholds (S03) and determines whether to perform dynamic image quality control based on the evaluation results (S04).

If it is determined not to perform dynamic image quality control (NO in S04), the image quality adjusting device 12 waits for predetermined timing (S05). In this case, instead of performing image quality control in real time, the image quality adjusting device performs image quality control at predetermined timing, i.e., in a batch processing mode (static control). If it is determined to perform dynamic image quality control (YES in S04) or after step S05, the image quality adjusting device 12 generates look-up tables for image quality adjustment (S06) and adjusts the image quality of the display terminal 11 based on the generated look-up tables (S07).

Then, the image quality adjusting device 12 determines whether all display terminals 11 have been processed (S08). If there are remaining display terminals 11 (NO in S08), the image quality adjusting device 12 returns to step S01 and repeats the above described steps for the remaining display terminals 11. Meanwhile, if all the display terminals 11 have been processed (YES in S08), the image quality adjusting device 12 terminates the process.

The above method makes it possible to quantitatively analyze and evaluate the image quality of a display terminal in a cost-effective manner and thereby makes it possible to accurately adjust the image quality of the display terminal. This method may be applied to any type of image display equipment.

### <Configuration of Imaging Unit 21>

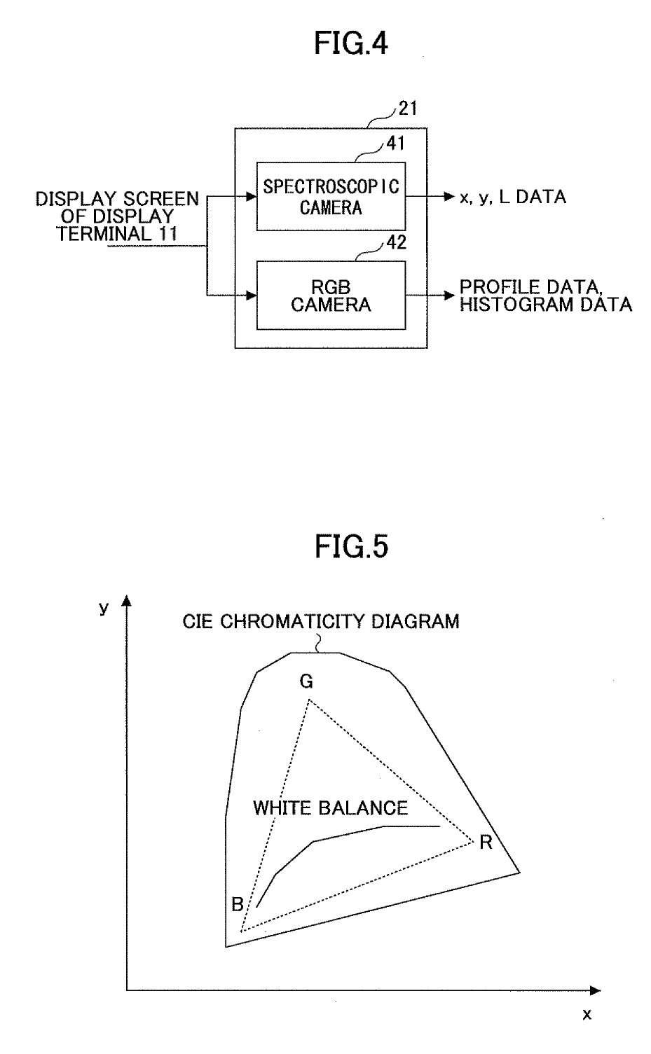

An exemplary configuration of the imaging unit 21 is described below. FIG. 4 is a drawing illustrating an exemplary configuration of an imaging unit. As illustrated in FIG. 4, the imaging unit 21 may include a spectroscopic camera (or spectrograph) 41 and an RGB camera 42. The spectroscopic camera 41 measures x, y, and L values on the CIE chromaticity coordinate system based on, for example, the luminance information of the display screen of the display terminal 11. The RGB camera 42 is used to obtain the color level information of the display screen of the display terminal 11 and thereby to obtain profile data and histogram data indicating video image characteristics of respective pixels.

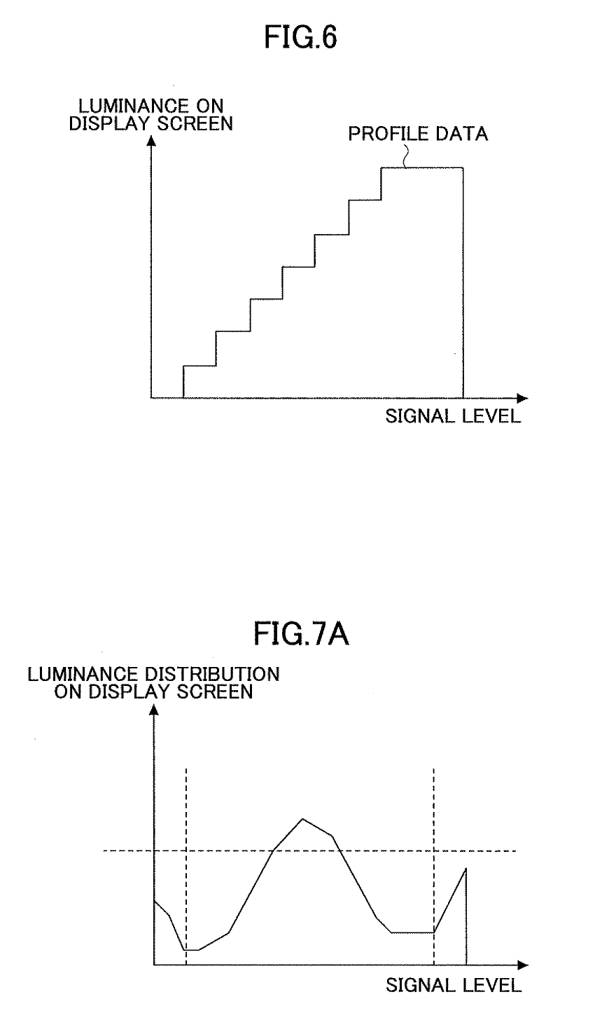

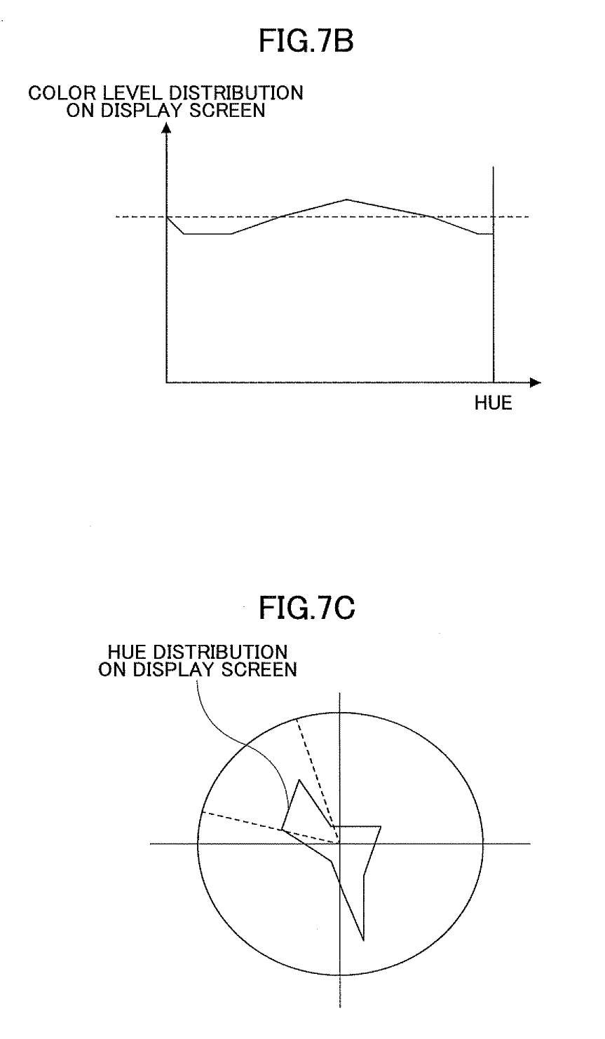

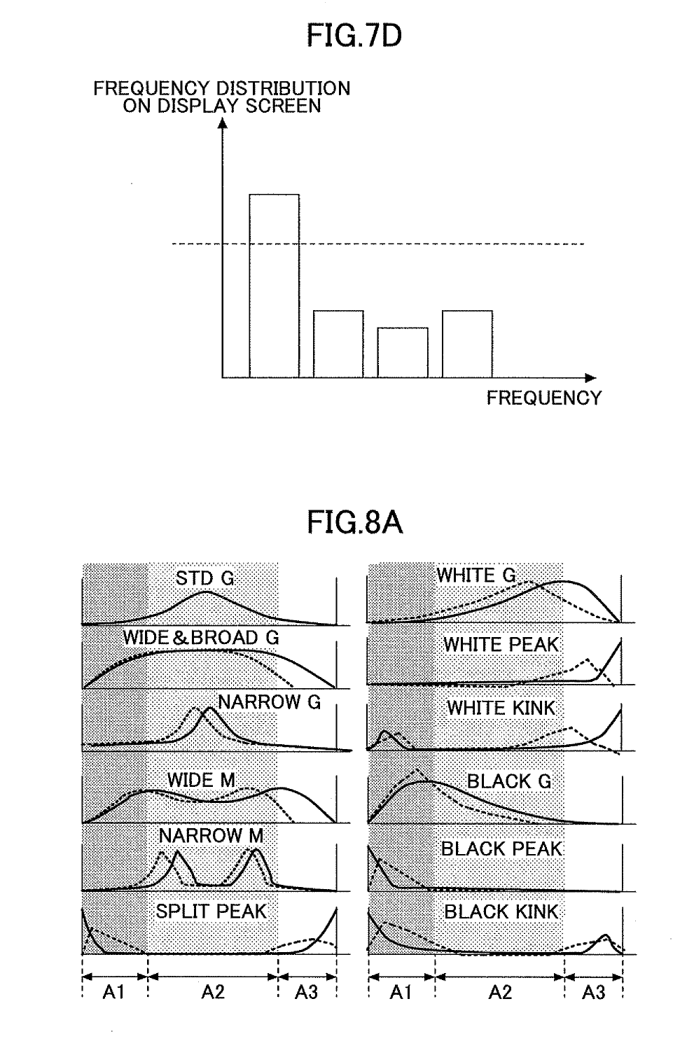

FIG. 5 is a graph showing exemplary x, y, and L values measured by the spectroscopic camera 41. FIG. 6 is a graph showing an exemplary profile obtained by the RGB camera 42. FIGS. 7A through 7D are graphs showing exemplary histograms obtained by the RGB camera 42.

In FIG. 5, the x and y values indicate CIE chromaticity coordinates that accurately represent color level information. The L value indicates luminance information that can be used to analyze, for example, the color level, the range of colors (Gamut range) that can be expressed, and the white balance.

The profile shown in FIG. 6 is waveform data for signal analysis. The waveform data are obtained by converting luminance and color level information obtained by the RGB camera 42 from digital to analog. In FIG. 6, the vertical axis indicates a luminance level on the display screen and the horizontal axis indicates a signal level. The profile shown in FIG. 6 makes it possible to analyze, for example, linear/non-linear control characteristics of contrast, a noise level, Y-C delay timing, resolution characteristics, and pulse response characteristics.

The histograms shown in FIGS. 7A through 7D represent histogram distributions (histogram data) of luminance and color information of pixels obtained by the RGB camera 42 and corresponding to the input signal resolution. In this embodiment, luminance histogram distribution data (FIG. 7A), color level histogram distribution data (FIG. 7B), hue histogram distribution data (FIG. 7C), and frequency histogram distribution data (FIG. 7D) are obtained. These histogram distribution data make it possible to obtain, for example, a luminance distribution, contrast information, color reproduction information, and frequency component information.

Thus, using luminance information and color level information obtained by the spectroscopic camera 41 and the RGB camera 42 makes it possible to accurately analyze the image quality of a display terminal.

Accordingly, this embodiment makes it possible to obtain information on the image quality from three information sources, i.e., human eyes, the spectroscopic camera 41, and the RGB camera 42 and thereby makes it possible to provide an automatic image quality adjusting system that can quantitatively, accurately, and quickly evaluate, analyze, and adjust the image quality of a display terminal in a cost-effective manner.

### <Generation of LUT>

A method of generating look-up tables by categorizing image quality measurements obtained by the spectroscopic camera 41 and the RGB camera 42 into patterns is described below. In this embodiment, the signal image quality adjusting unit 23 generates look-up tables based on conditions that are set by using the setting unit 26.

The signal image quality adjusting unit 23 generates look-up tables by categorizing image quality characteristics represented by image quality evaluation data into patterns. The image quality evaluation data may include color data, profile data, and histogram data as shown by FIGS. 5 through 7D. In this embodiment, two look-up tables are prepared and a closest pattern is selected from each of the look-up tables and used for image quality control. One of the two look-up tables includes luminance histogram patterns for controlling image quality based mainly on luminance and contrast. The other one of the two look-up tables includes color histogram patterns for controlling image quality based mainly on the color level and hue. Histogram data in each of the look-up tables are compared with a pattern predefined by using, for example, the setting unit 26 and control parameters are set based on the comparison results to obtain optimum image quality. An exemplary process for setting control parameters is described below.

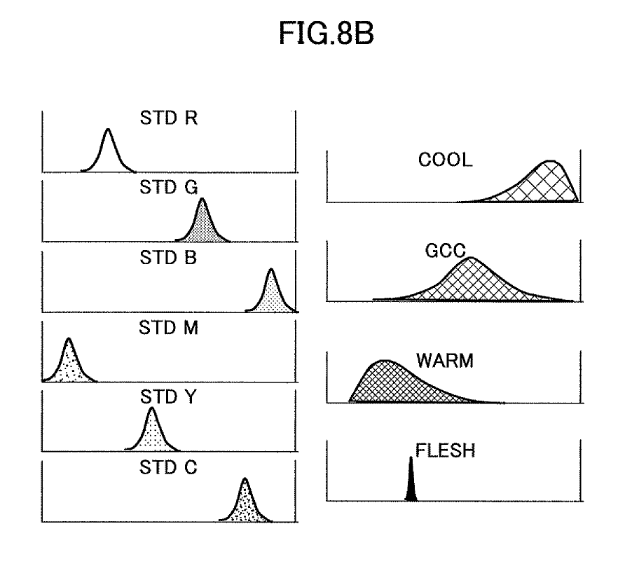

FIGS. 8A and 8B illustrate exemplary look-up tables generated in this embodiment. FIG. BA illustrates an exemplary look-up table including luminance histogram patterns, and FIG. 8B illustrates an exemplary look-up table including color histogram patterns. The look-up tables of FIGS. 8A and 8B may be displayed on the display unit 25 for review by the user.

The look-up table of FIG. 8A includes, but is not limited to, the following 12 luminance histogram patterns: “STD G”, “Wide&Broad G”, “Narrow G”, “Wide M”, “Narrow M”, “Split Peak”, “White G”, “White Peak”, “White Kink(rebound)”, “Black G”, “Black Peak”, and “Black Kink”.

The above luminance histogram patterns are used for image quality control based, for example, on the following conditions:

(1) The luminance histogram is divided into the following three areas: a dark area (A1), an intermediate luminance area (A2), and a bright area (A3).

(2) The dark area is corrected based on “black stretch” or an S-curve (sigmoid curve).

(3) S-curve correction linked with the average picture level (APL) is performed on the intermediate luminance area.

(4) When the APL is low, the bright area is maintained at the peak luminance level; and when the APL is high, S-curve correction and white peak suppressor (WPS) correction are performed on the bright area.

It is possible to accurately and quickly perform dynamic luminance and contrast control by comparing an input signal with the look-up table including the 12 luminance histogram patterns.

The look-up table of FIG. 8B includes, but is not limited to, the following 10 color (color level and hue) histogram patterns: “STD R”, “STD G”, “STD B”, “STD M”, “STD Y”, “STD C”, “Cool”, “GCC (green color control)”, “Warm”, and “Flesh”.

The above color histogram patterns are used for image quality control based, for example, on the following conditions:

(1) The following three typical hue areas 30 degrees) are used: Warm, Green, and Cool.

(2) When Warm is dominant, fresh tone correction is performed near a white balance of 6500.

(3) When Green is dominant, green tone correction is performed near a white balance of 9300.

(4) When Cool is dominant, blue tone correction is performed near a white balance of 12000.

Image quality control is performed on an input signal based on the above conditions. Using the look-up table including the 10 color histogram patterns makes it possible to accurately and quickly perform dynamic color quality control. For example, image quality control can be performed by using control parameters preset for the corresponding pattern.

Here, care should be taken when performing white color correction at a white balance of 6500 (it is difficult to obtain optimum white color) and performing red color correction at a white balance of 9300 or 12000 (it is difficult to obtain optimum red color). For white color correction at a white balance of 6500, blue stretch correction and/or white stretch correction are effective. For red color correction at a white balance of 9300 or 12000, fresh tone correction is effective. The above conditions may be stored in a storage unit to quickly perform optimum and effective image quality settings.

In this embodiment, as described above, the waveform of an input signal is analyzed to select one corresponding histogram pattern from each one of the look-up table including the 12 luminance histogram patterns and the look-up table including the 10 color histogram patterns, and the image quality is adjusted based on image quality control parameters defined for the combination of the selected histogram patterns. Look-up tables other than those described above may also be used for this purpose.

### <Configuration of Image Control System>

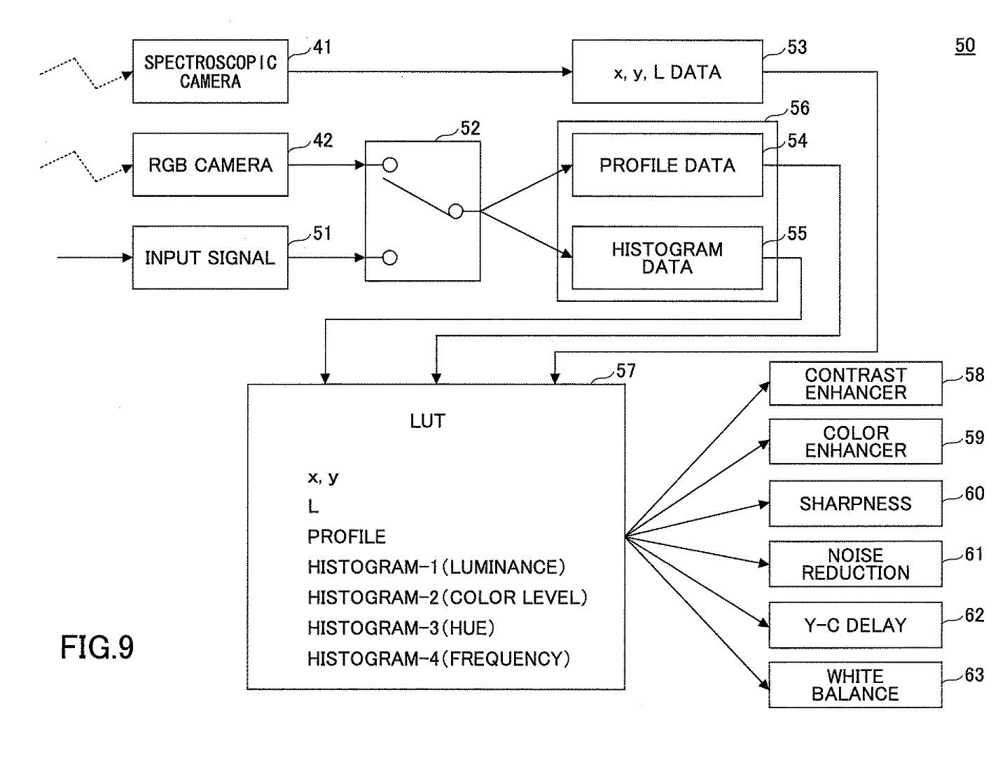

An exemplary configuration of an image control system is described below. FIG. 9 is a drawing illustrating an exemplary configuration of an image control system 50. As illustrated in FIG. 9, in the image control system 50, the spectroscopic camera 41 and the RGB camera 42 capture a still image and a video image displayed on the display terminal 11 to provide image signals. Also, an input signal 51 is directly input from the display terminal 11.

As described above, the spectroscopic camera 41 outputs x, y, L data 53. The image control system 50 includes a switching unit 52 for switching between the RGB camera 42 and the input signal 51 from the display terminal 11. The image control system 50 also includes a profile-histogram obtaining unit 56 that obtains profile data 54 and histogram data 55 from each of the two signals switched by the switching unit 52.

The image control system 50 generates a look-up table (LUT) 57 based on the x, y, L data 53 obtained from the image signal of the spectroscopic camera 41 and the profile data 54 and the histogram data 55 obtained from the image signals of the RGB camera 42 and the input signal 51. The LUT 57 includes, for example, x, y, and L values; a profile, a luminance histogram (histogram-1), a color level histogram (histogram-2), a hue histogram (histogram-3), and a frequency histogram (histogram-4). Although the LUT 57 includes four histograms in this example, the number and types of histograms are not limited to those shown in FIG. 9. Also, the number and types of look-up tables are not limited to those shown in FIG. 9. For example, more than one look-up table of different types may be generated.

Based on the data contained in the LUT 57, a contrast enhancer 58, a color enhancer 59, sharpness 60, noise reduction 61, Y-C delay 62, and a white balance 63 in an image quality table preset in the display terminal 11 are updated to adjust the image quality. The contents of the image quality table to be updated are not limited to those shown in FIG. 9.

As described above, the image control system includes two signal input terminals for the input signal 51 and the RGB camera 42, and the two signal input terminals are alternately connected by the switching unit 52 to the profile-histogram obtaining unit 56 for generating the profile data 54 and the histogram data 55. The switching unit 52 may be configured to switch between the two signals by time division or may be connected statically to one of the two terminals. In the image control system 50, the above described control process may be performed based on predetermined thresholds.

In this embodiment, instead of providing two obtaining units (a profile generating (obtaining) unit and a histogram generating (obtaining) unit), the profile-histogram obtaining unit 56 with the functions of the two obtaining units is provided. Using one generating circuit by time division makes it possible to simplify the circuit configuration and to prevent variations between two generating circuits. However, the profile-histogram obtaining unit 56 may be divided into two obtaining units if the variations and the speed are not important factors.

As described above, this embodiment makes it possible to adjust the image quality based on three sets of basic data: image data and x, y, L data from the spectroscopic camera 41; image data, profile data, and histogram data from the RGB camera 42; and image data, profile data, and histogram data from the input signal 51. Also, this embodiment provides control methods such as a static control method, a threshold control method, and a look-up table (LUT) control method where analysis results are approximated to evaluation patterns.

Also in this embodiment, profile data and histogram data are obtained by analyzing an input signal and a similar pattern is identified based on the profile data and the histogram data to more accurately and quickly improve the image quality.

It is also possible to obtain a high image quality by analyzing image quality characteristics of a high quality display terminal used as a comparative model and adjusting the image quality characteristics of a display terminal to those of the high quality display terminal.

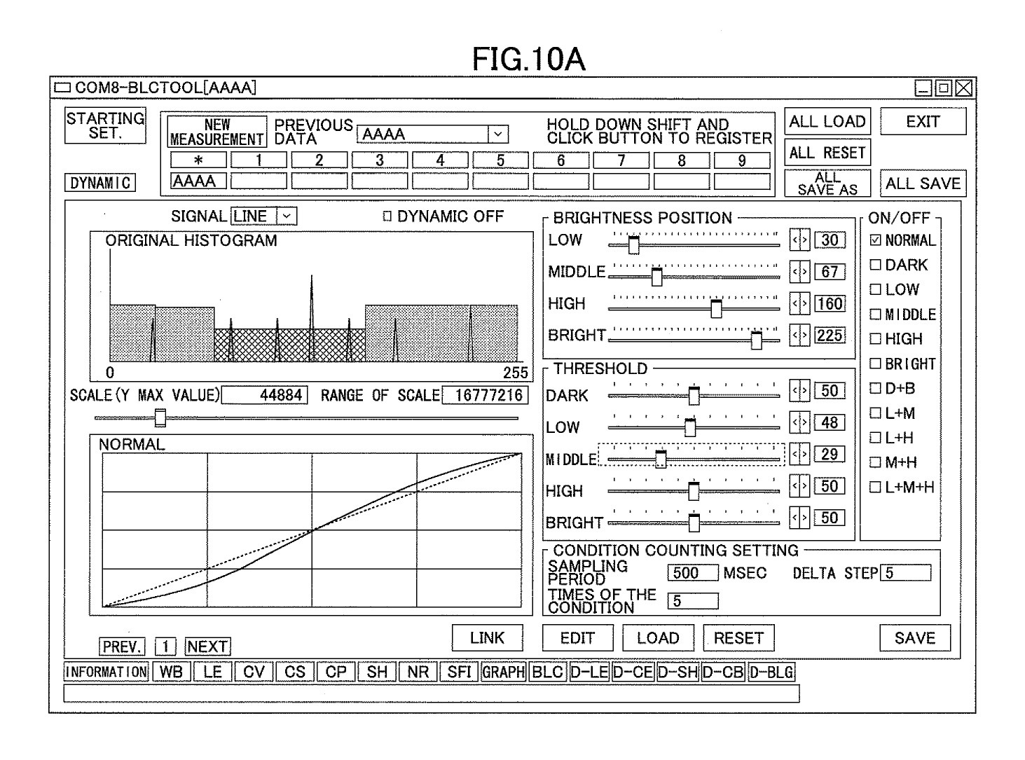

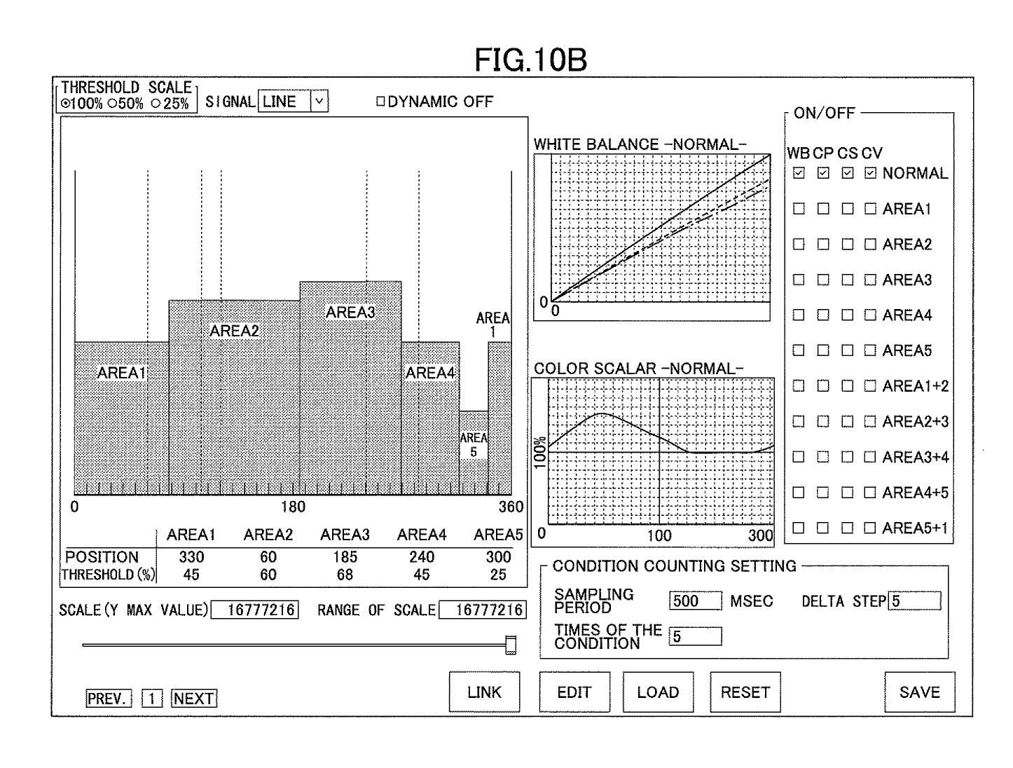

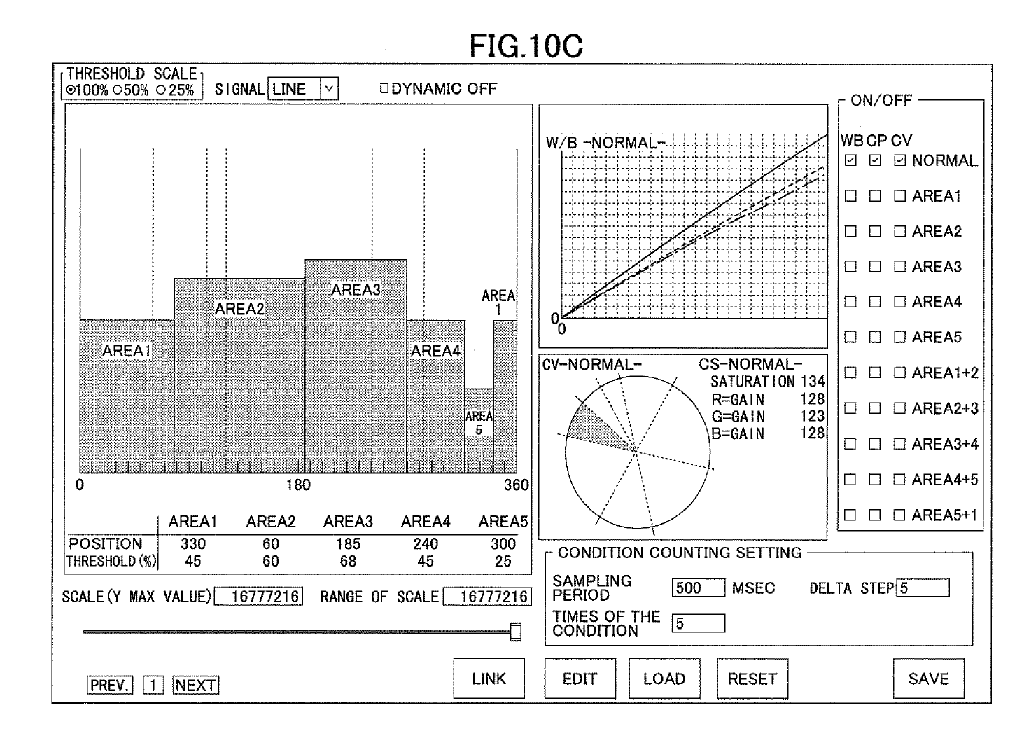

Other examples of automatic and dynamic image quality adjustment are described below. FIGS. 10A through 10C illustrate exemplary setting screens for dynamic image quality adjustment. FIG. 10A illustrates a setting screen for automatic luminance detection enhancement control, FIG. 10B illustrates a setting screen for automatic color scalar detection enhancement control, and FIG. 10C illustrates a setting screen for automatic color vector enhancement control. These setting screens are displayed, for example, by the display unit 25 to set parameters using the setting unit 26.

The setting screen of FIG. 10A is used to set various conditions for dynamic control of a luminance correction LUT based on a luminance histogram. In this example, the horizontal axis (luminance) of the luminance histogram is divided into five areas that are defined as “Dark”, “Low”, “Middle”, “High”, and “Bright” from the left. However, the number of areas is not limited to five. For example, the horizontal axis may be divided into three areas defined as “Low”, “Middle”, and “High”.

For each area, an area width is set using “Brightness Position” and a threshold is set using “Threshold”. A luminance correction LUT is assigned to each area and each combination of areas. The condition for selecting the luminance correction LUT is an area or a combination of areas where the luminance is greater than the threshold(s). For example, “Normal” indicates that there is no such area or an ON/OFF setting is not checked. The threshold is represented by a percentage in the total number of pixels “m” on the screen. For example, when “th” indicates a threshold, if the number of pixels in an area is greater than “m×th/100”, it is determined that the area exceeds the threshold.

The priority levels of “Dark” and “Bright” are set at values greater than those of “Low”; “Middle”, and “High”.

Accordingly, if the “Dark” and “Bright” areas are greater than the thresholds, the “Low”, “Middle”, and “High” areas are disregarded and the condition becomes “Dark”, “Bright”, or the combination of them (Dark+Bright).

In “Original Histogram” shown in FIG. 10A, a luminance histogram of an original image is displayed. Also in “Original Histogram”, positions (or ranges) of the areas and the thresholds set as described above are superposed on the luminance histogram. An area where the luminance is greater than a threshold may be highlighted (e.g., indicated in red) to distinguish the area from other areas. It is possible to perform dynamic control of the luminance correction LUT based on the histogram displayed as described above.

The setting screens of FIGS. 10B and 10C may also be set in a similar manner. The value in “Scale” in FIGS. 10A through 10C corresponds to the top end of the vertical axis of the histogram and can be changed using a slider or an edit box. It is possible to change the height of the displayed histogram by changing the value in “Scale”. “Range of Scale” allows editing the upper limit of the variable range of the slider for “Scale”. “Sampling Period” allows setting the interval of dynamic control (the interval for reading the histogram and checking the conditions) in milliseconds.

“Times of the Condition” allows setting the number of consecutive occurrences of a condition exceeding the threshold. If the condition consecutively occurs for the specified number of times, the luminance correction LUT is changed. “Brightness Position” is used to set the widths of the five areas (left ends of the areas). The left end of the Dark area is fixed at 0.

The setting screens of FIGS. 10B and 10C function as “Dynamic Color Enhancer” and are used to set various conditions for dynamic control of a luminance correction LUT based on a hue histogram. The horizontal axis (luminance) of the hue histogram is divided into seven areas (“Magenta”, “Red”, “Skin”, “Yellow”, “Green”, “Cyan”, and “Blue”) with their centers at the positions of Red, Green, Blue, Cyan, Magenta, Yellow, and Skin. Different from the luminance histogram, there may be gaps between the areas.

“Width” of “Setting” allows adjusting the width of each area, and “Position” allows adjusting the center position of each area. A color correction LUT and basic color settings are defined for each area. If there is an area that exceeds a predetermined threshold level, the corresponding definitions are set in the hardware. The histogram is obtained and the threshold conditions are checked at the interval specified in “Sampling Period”. If the condition exceeding the threshold consecutively occurs for the number of times specified in “Times of the Condition”, the color correction LUT is changed. That is, if “1” is set in “Times of the Condition”, the settings are changed immediately. The threshold is indicated by a percentage in the total number of pixels.

In this embodiment, at least one of the following image quality parameters is adjusted: the contrast enhancer 58, the color enhancer 59, the sharpness 60, the noise reduction 61, the Y-C delay 62, and the white balance 63.

### <Configuration of Image Quality Adjusting System>

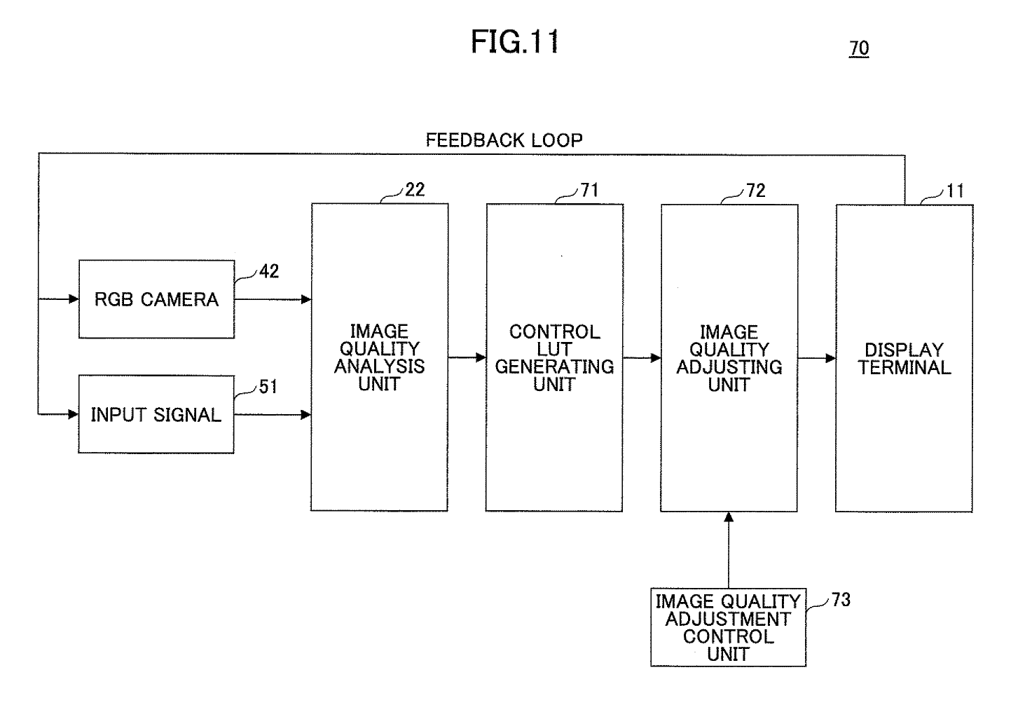

An exemplary configuration of an image quality adjusting system according to another embodiment of the present invention is described below. FIG. 11 is a drawing illustrating an exemplary configuration of an image quality adjusting system 70 of this embodiment. The same reference numbers are assigned to the corresponding components in FIG. 1 and FIG. 11, and descriptions of those components are omitted here.

The image quality adjusting system 70 of FIG. 11 includes an input signal 51, an RGB camera 42, an image quality analysis unit 22, a control LUT generating unit 71, an image quality adjusting unit 72, an image quality adjustment control unit 73, and a display terminal 11.

In the image quality adjusting system 70, an image on the screen of the display terminal 11 is captured by the RGB camera 42 to obtain profile data and histogram data and an image quality adjustment LUT is generated based on the profile data and the histogram data to automatically perform image quality control. With the image quality adjusting system 70 of FIG. 11, measurement data of the spectroscopic camera 41 may be evaluated in advance for correction of data obtained by the RGB camera 42 and it is possible to automatically adjust, the image quality using only the RGB camera 42 during an actual automatic image quality adjusting process. The image quality adjustment control unit 73 sets thresholds in advance for profile data and histogram data obtained by an analysis process (the image quality analysis unit 22) and causes the image quality adjusting unit 72 to statically or dynamically perform image quality adjustment. This configuration makes it possible to statically or dynamically perform image quality adjustment based on the status of a production line of display terminals and the analysis results of the display terminals.

The image quality adjustment control unit 73 also generates an image quality adjustment look-up table based on profile data and histogram data obtained by an analysis process and dynamically performs feedback control on the display terminal 11. This configuration makes it possible to quickly perform feedback control for image quality adjustment using the image quality adjustment look-up table.

### <Advantageous Effects>

The above embodiments make it possible to provide various image adjustment methods. For example, the above embodiments make it possible to adjust the image quality by visually inspecting a display screen (an actual image), to adjust the image quality by evaluating profile data and histogram data of an input image signal, and to adjust the image quality using profile data and histogram data of an RGB camera.

Also, the above embodiments make it possible to adjust the image quality using profile data and histogram data obtained from both an input signal and an

RGB camera. The above embodiments make it possible to set up a feedback loop for measurement and evaluation based on quantitative data obtained by evaluating a camera signal and an input signal and thereby make it possible to easily set up an automatic adjustment system.

The above embodiments make it possible to quantitatively evaluate and adjust image quality during design and development stages and thereby make it possible to speed up the design and development. The above embodiments make it possible to quantitatively evaluate the image quality of mass-produced display terminals and to automatically adjust the image quality in a cost-effective manner. This in turn makes it possible to improve the definition and the image quality of display terminals. Also, the above embodiments make it possible to speed up the factory production and make it easier to manage the variation in image quality between production lots. Further, the above embodiments make it possible to store history data of image quality adjustment in a ROM of each product and thereby make it easier to provide support services.

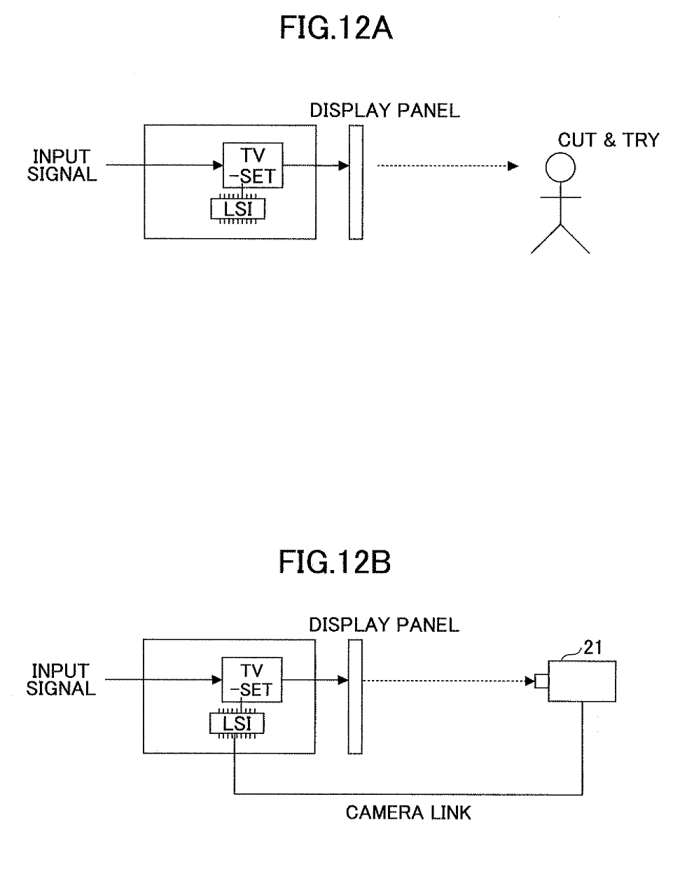

FIG. 12A is a drawing illustrating a related-art system including an image quality adjusting device, and FIG. 12B is a drawing illustrating a system including an image quality adjusting device according to an embodiment of the present invention. In FIGS. 12A and 12B, it is assumed that the image quality adjusting device is incorporated in an image processing LSI (large scale integration) or a television set (TV-set).

In the related art, as illustrated in FIG. 12A, an engineer visually inspects the display screen and controls the image quality using a control key or a remote control of the TV-set. In this embodiment, as illustrated in FIG. 12B, an image on the display screen is captured by the imaging unit 21 such as a camera to obtain an image signal and the image signal is input to the image quality adjusting device in the LSI or the TV-set via, for example, a camera link. This configuration makes it possible to automatically control the image quality. The latter method is preferable for a mass-production process or a maintenance service of television sets.

An image quality adjusting device of the above embodiments may be incorporated in an LSI or a television set together with a function for analyzing and controlling an input image signal. This configuration makes it possible to automatically, accurately, and economically perform image quality adjustment in any place based on an image signal obtained by a camera connected via a line such as a camera link to the LSI or the television set.

The above embodiments of the present invention make it possible to accurately and consistently adjust image quality characteristics of multiple display terminals. For example, a television image is captured by an evaluation camera to obtain image quality parameters and the image quality parameters are adjusted to match reference values (typical values). This method makes it possible to adjust mass-produced television sets to have uniform image quality characteristics and thereby to prevent variations between the television sets.

More specifically, a television image on a television screen is captured by an evaluation camera to obtain an image signal and an image quality characteristic is analyzed using an IC based on the image signal. If the image quality characteristic deviates from a threshold (or a typical parameter value), the image quality characteristic is adjusted to match the typical parameter value to achieve uniform image quality.

Also, in addition to capturing a television image using an evaluation camera as described in the above embodiments, an evaluation signal may be output from the television to an IC (including an image quality analysis function and an image quality correction function) to analyze the image quality.

Quantitative evaluation data provided by the above embodiments are useful for all stages of the product life cycle such as design, development, production, sales, and service. Also, accumulating such quantitative evaluation data may help improve the quality of products. Further, the above embodiments of the present invention make it possible to develop an accurate automatic adjusting system used in a production stage.

The present invention is not limited to the specifically disclosed embodiments, and variations and modifications may be made without departing from the scope of the present invention.

The present international application claims priority from Japanese Patent Application No. 2008-218523 filed on Aug. 27, 2008, and Japanese Patent Application No. 2009-190665 filed on Aug. 20, 2009, the entire contents of which are hereby incorporated herein by reference.

### EXPLANATION OF REFERENCES

10 Image quality adjusting system
11 Display terminal
12 Image quality adjusting device
21 Imaging unit
22 Image quality analysis unit
23 Signal image quality adjusting unit
24 Backlight control unit
25 Display unit
26 Setting unit
31 Input unit
32 Output unit
33 Drive unit
34 Secondary storage unit
35 Memory
36 Central processing unit (CPU)
37 Network connection unit
38 Storage medium
41 Spectroscopic camera
42 RGB camera
50 Image control system
51 Input signal
52 Switching unit
53 x, y, L data
54 Profile data
55 Histogram data
56 Profile-histogram obtaining unit
57 Look-up table (LUT)
58 Contrast enhancer
59 Color enhancer
60 Sharpness
61 Noise reduction
62 Y-C delay
63 White balance
70 Image quality adjusting system
71 Control LUT generating unit
72 Image quality adjusting unit
73 Image quality adjustment control unit

1. A device for adjusting image quality of image information displayed on a screen of a display terminal, the device comprising:
an imaging unit capturing the screen of the display terminal using a spectroscopic camera and an RGB camera to obtain the image information;
an analysis unit obtaining color data, profile data, and histogram data from the image information obtained by the imaging unit and analyzing image quality characteristics including still image characteristics and video image characteristic; and
an image quality adjusting unit
generating a look-up table (LUT), which is used to adjust the image quality of the display terminal by means of predetermined image quality adjustment parameters, based on image quality evaluation data of the display terminal obtained by the analysis unit, and
updating image quality information preset in the display terminal based of the generated look-up table to adjust the image quality of the display terminal.

2. The device as claimed in claim 1, further comprising:
a switching unit switching between an input signal input from the display terminal and a camera signal obtained by the RGB camera; and
a profile-histogram obtaining unit obtaining the profile data and the histogram data from each one of the input signal and the camera signal switched by the switching unit,

3. The device as claimed in claim 1, further comprising:
an image quality adjustment control unit setting thresholds in advance for the profile data and the histogram data obtained by the analysis unit and causing the image quality adjusting unit to statically or dynamically adjust the image quality based on the thresholds.

4. The device as claimed in claim 3, wherein the image quality adjustment control unit generates an image quality adjustment look-up table based on the profile data and the histogram data obtained by the analysis unit and dynamically performs feedback control on the display terminal.

5. A method for adjusting image quality of image information displayed on a screen of a display terminal, the method comprising:
an image signal obtaining step of capturing the screen of the display terminal by an imaging unit including a spectroscopic camera and an RCB camera to obtain an image signal indicating the image information;
an analysis step of obtaining color data, profile data, and histogram data from the image information of a still image or a video image obtained in the image signal obtaining step and analyzing image quality characteristics including still image characteristics and video image characteristics; and
an image quality adjusting step of
generating a look-up table (LUT), which is used to adjust the image quality of the display terminal by means of predetermined image quality adjustment parameters, based on image quality evaluation data of the display terminal obtained in the analysis step, and
updating image quality information preset in the display terminal based of the generated look-up table to adjust the image quality of the display terminal.

6. The method as claimed in claim 5, further comprising:
a switching step of switching between an input signal input from the display terminal and a camera signal obtained by the RGB camera; and
a profile-histogram obtaining step of obtaining the profile data and the histogram data from each one of the input signal and the camera signal switched in the switching step.

7. The method as claimed in claim 5, further comprising:
an image quality adjustment control step of setting thresholds in advance for the profile data and the histogram data obtained in the analysis step and causing the image quality to be adjusted statically or dynamically based on the thresholds in the image quality adjusting step.

8. The method as claimed in claim 7, wherein the image quality adjustment control step further comprises generating an image quality adjustment look-up table based on the profile data and the histogram data obtained in the analysis step and dynamically performing feedback control on the display terminal.

9. A non-transitory computer-readable storage medium having a program stored therein for causing a computer to perform a method of adjusting image quality of image information displayed on a screen of a display terminal, the method comprising:
an image signal obtaining step of capturing the screen of the display terminal by an imaging unit including a spectroscopic camera and an ROB camera to obtain an image signal indicating the image information;
an analysis step of obtaining color data profile data, and histogram data from the image information of a still image or a video image obtained in the image signal obtaining step and analyzing image quality characteristics including still image characteristics and video image characteristics; and
an image quality adjusting step of
generating a look-up table (LUT), which is used to adjust the image quality of the display terminal by means of predetermined image quality adjustment parameters, based on image quality evaluation data of the display terminal obtained in the analysis step, and
updating image quality information preset in the display terminal based of the generated look-up table to adjust the image quality of the display terminal,

10. The storage medium as claimed in claim 9, the method further comprising:
a switching step of switching between an input signal input from the display terminal and a camera signal obtained by the RGB camera; and
a profile-histogram obtaining step of obtaining the profile data and the histogram data from each one of the input signal and the camera signal switched in the switching step.

11. The storage medium as claimed in claim 9, the method further comprising:
an image quality adjustment control step of setting thresholds in advance for the profile data and the histogram data obtained in the analysis step and causing the image quality to be adjusted statically or dynamically based on the thresholds in the image quality adjusting step.

12. The storage medium as claimed in claim 11, wherein the image quality adjustment control step further comprises generating an image quality adjustment look-up table based on the profile data and the histogram data obtained in the analysis step and dynamically performing feedback control on the display terminal.
